(19) United States
(12) Patent Application Publication
(10) Pub. No.: US 2025/0263245 A1
(43) Pub. Date: Aug. 21, 2025

(54) SECURITY INSPECTION SYSTEM AND SECURITY INSPECTION METHOD

(71) Applicant: HÖRMANN KLATT CONVEYORS GMBH, Neumarkt a. Wallersee (AT)

(72) Inventor: Peter Klatt, Neumarkt a. Wallersee (AT)

(21) Appl. No.: 18/709,149

(22) PCT Filed: Nov. 11, 2022
(86) PCT No.: PCT/EP2022/081615

§ 371 Date: Jul. 11, 2024

(30) Foreign Application Priority Data
Nov. 12, 2021 (DE) 10 2021 129 504.1

(51) Int. Cl. B65G 43/00; G01V 5/20; G07C 9/32

(52) U.S. Cl. CPC B65G 43/00; G01V 5/20; G07C 9/32; B65G 2201/0264

(57) ABSTRACT

The security inspection system according to the invention essentially consists of
a luggage drop-off region (1) having one or more drop-off stations (1a, 1b, 1c) for dropping off luggage belonging to a person into a load carrier (2),
a luggage inspection station (3) for imaging inspection of the luggage,
a luggage pick-up region (6) having one or more removal stations (6a, 6b, 6c), and
a transport system (8) for transporting the load carriers (2) laden with luggage from the luggage drop-off region via the luggage inspection station (3) to the luggage pick-up region (6) and for returning empty load carriers (2) to the luggage drop-off region,
   wherein at least one first monitoring device (15) is provided in each of the provided drop-off stations (1a, 1b, 1c) for detecting the loading state of the load carrier (2), and/or at least one second monitoring device (25) is provided in each of the provided removal stations (6a, 6b, 6c) for detecting the loading state of the load carrier.

The invention relates to a security inspection system and a security inspection method for inspecting a person's luggage.

The security inspection of persons, in particular passengers and their hand luggage, is an integral part of every flight. Whether within Europe or internationally, the procedures and the appearance of the associated facilities have further developed only insubstantially in recent decades, which is due not least to the official requirements that specify the equipment to be used and the procedures to be followed. In recent years, however, innovations have been considered, and the use of more modern technologies, such as the use of computer tomography to produce images for hand luggage inspection, has been gradually approved.

Due to the increasing number of air passengers, airport operators have an increased interest in increasing the efficiency of security inspections and reducing personnel costs through automation and monitoring of processes.

EP 2 684 166 B1 proposes an automated passenger inspection system for this purpose, in which passengers deposit their luggage into a load carrier at a luggage drop-off region, wherein a personal identifier of the passenger is detected and linked to the load carrier. While the luggage undergoes an imaging luggage inspection, the passengers undergo a personal inspection. Passengers then go to a luggage pick-up region, where the load carrier linked to their personal identifier is made available for emptying.

WO 2020/249192 A1 also discloses an automated security inspection system which provides an inspection device after the luggage pick-up region which is designed to determine the loading state and the degree of soiling of a load carrier.

The invention is based upon the object of further increasing the efficiency of security inspections.

According to the invention, this object is achieved by the features of claims 1 and 14.

The security inspection system according to the invention essentially consists of
a luggage drop-off region with one or more drop-off stations for dropping off a person's luggage into at least one load carrier,
a luggage inspection station for imaging inspection of the luggage,
a luggage pick-up region with one or more removal stations, and
a transport system for transporting the load carriers laden with luggage from the luggage drop-off region via the luggage inspection station to the luggage pick-up region and for returning empty load carriers to the luggage drop-off region,
   wherein at least one first monitoring device for detecting the loading state of the load carriers is provided in each of the provided drop-off stations, and/or at least one second monitoring device for detecting the loading state of the load carriers is provided in each of the provided removal stations.

The security inspection method according to the invention is characterized by the following method steps:
a person in a luggage drop-off region with one or more drop-off stations drops his or her luggage into at least one load carrier provided at a drop-off station,
the luggage is subjected to imaging examination at a luggage inspection station,
the person picks up his or her luggage in a luggage pick-up region having one or more removal stations, and
the load carriers laden with luggage are transported from the luggage drop-off region via the luggage inspection station to the luggage pick-up region, and the empty load carriers are transported back to the luggage drop-off region.

In addition, in each of the provided drop-off stations, the loading state of the load carrier is monitored by means of at least one first monitoring device, and/or, in each of the provided removal stations, the loading state of the load carrier is monitored by means of at least one second monitoring device.

Conventional X-ray machines are still often used for imaging luggage in the luggage inspection station, but these are increasingly being replaced by the much more effective computer tomographs. In both cases, the devices have limited entry openings, so that the correct loading state of the load carriers (transport boxes) must be observed in order to ensure the smooth transport of the load carriers laden with luggage through the luggage inspection station. According to the invention, the loading state is therefore already monitored at each drop-off station in order to thus make the person who is currently dropping off their luggage aware of incorrect loading in a timely manner so as to prompt the person to load it correctly.

In a corresponding manner, the second monitoring device is also provided in each removal station in order to make the person standing at the removal station aware if, for example, not all objects have yet been removed from the load carrier. If the load carrier is detected as empty by the second monitoring device, the transporting away of the load carrier can also be initiated in automated fashion, so that the passengers do not have to manually end the removal process after removing their items.

Further embodiments of the invention are the subject matter of the dependent claims.

The first monitoring device in the drop-off stations is preferably used to detect compliance with a specified degree of loading of the load carrier, but could also be used to document the load carrier contents. For example, it can be checked that the luggage does not extend past the dimensions of the load carrier. However, a marking could also be provided within the load carrier which specifies the maximum loading limit, wherein the first monitoring device checks that the maximum loading limit is not exceeded. However, the first monitoring device can also be designed to recognize items that have been dropped off and could thus ask about typical items, such as mobile phones, keys, belts, etc., during the dropping off, if these are not yet in the load carrier.

It is also conceivable that the first monitoring device recognize the load and give tips as to how to arrange the individual items in order to enable the most efficient stowage possible. In addition, the first monitoring device can be designed to recognize prohibited items, such as liquids or weapons, and to draw attention to them or initiate a notification to a security employee. In addition, animals or babies could be identified and reported.

The second monitoring device is used in particular to monitor the removal process in order to indicate in a timely manner that there are still objects in the load carrier. This could for example be indicated acoustically or visually in an appropriate manner.

Any suitable detector device and in particular a camera may be considered for the first and second monitoring devices.

According to a preferred embodiment of the invention, the first and/or second monitoring device comprises an information device for visually and/or acoustically displaying an indication regarding the loading state of the load carrier. In this way, attention can be drawn to an undesirable loading state at the drop-off station, in particular a piece of luggage that protrudes beyond a predetermined marking. Visually, an indication could, for example, be done using colored light. For example, the load carrier at the drop-off stations could initially be illuminated green, with the lighting changing to red as soon as an undesirable loading state is reached. In addition or alternatively, a suitable indication on a display or a flashing icon can also be communicated.

At the removal stations, attention can be drawn in particular to a load carrier that is not yet completely emptied. Here as well, a visual representation of an indication by means of colored light is conceivable, wherein the load carrier at the removal stations is initially illuminated red, and the lighting changes to green as soon as the last object has been removed. However, a suitable indication on a display or a flashing icon would also be conceivable in addition or as an alternative.

Furthermore, the first monitoring device can be coupled to the transport system and/or a provision system in order to block the removal of a load carrier during the dropping off of the luggage and/or in the event of an undesirable loading state of the load carrier.

A blockable exit for persons can optionally be provided in the luggage drop-off region or at each drop-off station, which exit can be blocked if an undesirable load state is detected—for example, luggage protruding beyond the dimensions of the load carrier. In this way, the person can load the load carrier correctly again themselves, as otherwise the load carrier would not be able to be transported away, and the pick-up station would thus not be available for the next person.

The load carrier is preferably box-shaped and has at least one opening, wherein the dimensions of the load carrier are expediently adapted to the entry opening of the luggage inspection station or the computer tomograph in such a way that the load carrier is made as large as possible on the one hand, and on the other can be transported through the computer tomograph without difficulty. Furthermore, it can optionally be provided that the load carrier be closed with a cover either automatically or by the person who has stowed the luggage in the load carrier.

In the luggage inspection stations, computer tomographs are preferably used, which are characterized by a significantly larger entrance opening compared to conventional X-ray machines, so that the load carriers can be made larger and can be loaded with more luggage, which means that one load carrier per person is usually sufficient. In addition, the visual representation for examining the luggage is significantly improved. In the case of computer tomographs that are certified in accordance with the C3 standard, larger electronic devices such as laptops, tablets, or cameras, as well as liquids, can remain in hand luggage during the luggage inspection, making it easier and quicker to place the luggage in the carrier.

According to the preferred embodiment of the invention, a first identification device for detecting a personal identifier, in particular biometric features, of the person is provided in each drop-off station, which first identification device cooperates with a data processing device for linking the personal identifier of the person with the load carrier in which the person's luggage is located. At each drop-off station, a personal identifier of the person can thus be detected by means of the first identification device, wherein the personal identifier of the person is linked by means of the data processing device to the load carrier in which the person's luggage is located.

In this way, the load carrier laden with the luggage is clearly assigned to the person to whom the luggage belongs. The first identification device can either be designed to detect the person's personal identifier for the first time, or it can be used to identify the person if the personal identifier is already stored in the system. For example, a person's personal identifier could be detected when entering the airport building or when dropping off large luggage. It is also conceivable for the person to generate their own personal identifier in advance of a trip, e.g., using a smartphone, and to upload it to the airline. In addition to the person's biometric characteristics, other personal identifiers, such as a code on the boarding pass, would also be conceivable. However, biometric features have the advantage that they can be easily captured with a camera, eliminating the need for the person to have the boarding pass or some other token scanned.

If the person has stowed their luggage in the load carrier provided, the following options for ending the process are in particular possible:

The person could use an input unit to confirm that the luggage has been placed in the load carrier, after which the load carrier would be transported away. However, it would also be conceivable for the person to signal the completion of the luggage drop-off by closing a cover on the load carrier, whereupon the load carrier is transported away. Finally, it would also be conceivable for the first monitoring device to detect luggage in the load carrier and for a sensor unit, which is formed for example by the first identification unit, to determine that there is no longer a person at the drop-off station for a predetermined period of time, whereupon the load carrier is transported away.

Furthermore, at least one buffer for a plurality of load carriers loaded with luggage can be provided in the luggage pick-up region, wherein a plurality of the removal stations are assigned to each buffer, and a provision system for transferring a load carrier laden with luggage from the buffer to one of the removal stations can be provided. People therefore do not have to go to a specific removal station, but can freely choose the removal station that next becomes available. However, depending upon the number of available removal stations, the person may be instructed to go to a specific zone of the luggage pick-up region, with each zone being assigned a number of pick-up stations.

In order to ensure that the correct load carrier is provided, each removal station is preferably equipped with a second identification unit for detecting the personal identifier of the person standing in front of the removal station, wherein the second identification unit is linked to the provision system in order to transfer the load carrier linked to the personal identifier of the person to this removal station. In addition, input and/or output units, in particular monitors and loudspeakers, are provided at the provided removal stations, which units are designed to provide information to the person and/or to confirm the emptying process of the load carrier by the person. Via the input and/or output units, the person can be made aware in particular that there are still pieces of luggage/objects in the load carrier. Using appropriate recognition software, people could be specifically alerted to a forgotten item—for example, by making the alert: “Please take your mobile phone.” After complete removal, for example the passenger can be wished a good flight, and/or the departure gate can be displayed, if this information is available. Another option would be to display advertising, which would provide an additional source of income.

In an advantageous embodiment, a sensor unit can be provided at the provided removal stations, which unit is formed for example by the second identification unit, which is designed to determine the presence of a person located in front of the removal station, and which is linked to the second monitoring unit and to the provision system in such a way that the emptying process is completed by transporting away the emptied load carrier if the sensor unit does not detect a person in front of the removal station and the load carrier is empty. In this way, the removal station can be made available to the next person as quickly as possible.

Of course, it is also conceivable that, after emptying the load carrier at the removal station, the person complete the emptying process by making an input at an input unit or by closing a lid or cover, and the load carrier then be transported away.

In the context of the invention, the luggage pick-up region can also have a follow-up inspection region for luggage objected to in the luggage inspection station, wherein preferably at least one of the above-described removal stations is provided in the follow-up inspection region. However, at the follow-up inspection stations, it may be possible to dispense with a re-identification.

Furthermore, the transport system can be designed to eject load carriers that are not completely emptied and/or are soiled, in order to prevent such load carriers from reaching one of the drop-off stations. Such load carriers are then transferred to a service or lost-and-found station. Since the load carriers are linked to the personal identifier of the associated person, the person can be paged specifically and asked to go to the lost-and-found station.

In the context of the invention, however, it would also be conceivable that soiled and/or not completely emptied load carriers could be transported to a free follow-up inspection station and could be cleaned there by an employee, or the passenger could pick up the forgotten items there. Here, there would also be the possibility that the not completely emptied load carrier would remain in the buffer system of the follow-up inspection region and would then be made available when the correct passenger appears.

At conventional drop-off and removal stations, luggage is dropped off and picked up in the presence of security personnel. With the system/method described above, it is no longer necessary for security personnel to be present at each drop-off or removal station. In many cases, it is sufficient for the security personnel to each be responsible for multiple drop-off or removal stations. The system/method according to the invention is therefore also characterized by enormous personnel savings, since the drop-off and removal stations require few personnel or none at all. Even with manual follow-up inspections, each follow-up inspection station only requires one inspector, although it would also be conceivable for one inspector to operate two follow-up inspection stations.

Further embodiments and advantages of the invention are explained in more detail with reference to the following description and the drawings.

In the drawings:

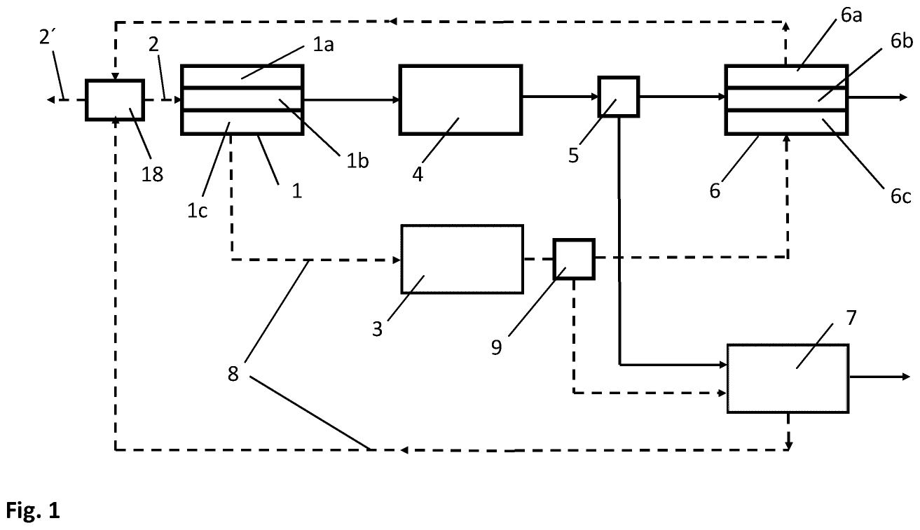

FIG. 1 is a block diagram of the security inspection system,

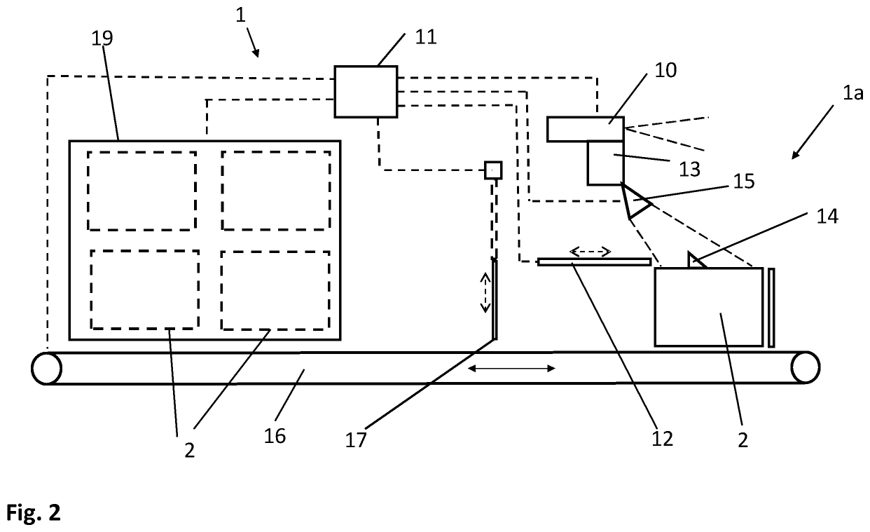

FIG. 2 is a schematic view of a detail of the luggage drop-off region with a drop-off station, and

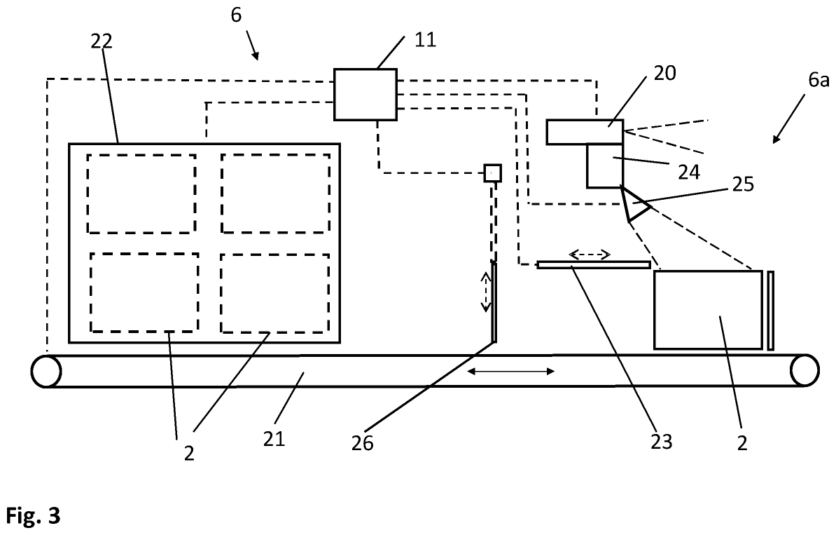

FIG. 3 is a schematic view of a detail of the luggage pick-up region with a removal station.

FIG. 1 shows an exemplary embodiment of a security inspection system according to the invention, shown as a block diagram. It provides a luggage drop-off region 1 with one or more drop-off stations 1a, 1b, 1c for dropping luggage off into a load carrier 2. The load carrier 2 laden with luggage is fed to a luggage inspection station 3 for imaging examination of the luggage, wherein a computer tomograph is preferably used there.

During the luggage inspection, the person goes to a person inspection station 4. For example, metal detectors and body scan devices as well as other devices can be used here.

The person inspection station 4 preferably has queuing and route systems that can control synchronization between luggage status and inspection of persons in a targeted manner. Thus, after the personal inspection has been completed, the person receives information at an information device 5 as to whether he or she should go to a luggage pick-up region 6 with one or more removal stations 6a, 6b, 6c to receive and empty the load carrier assigned to the person or to a follow-up inspection region 7 for manual follow-up inspection of his or her luggage. The routes for persons are illustrated with solid arrows.

Dashed arrows indicate a transport system 8 for transporting the load carriers 2 from the luggage drop-off region 1 via the luggage inspection station 3 to the luggage pick-up region 6 or to the follow-up inspection region 7 and for returning empty load carriers to the luggage drop-off region 1. After the luggage inspection station 3, a switch 9 is provided to divert the luggage objected to in the luggage inspection station 3 to the follow-up inspection region 7. By the time the switch is reached, the operator of the luggage inspection station (CT device) has to have made the decision as to whether a follow-up inspection is necessary. If a decision is not made in time, the load carrier 2 is automatically sent to the follow-up inspection region 7, so that there is no mixing of objected-to and non-objected-to pieces of luggage on the route to the luggage pick-up region 6.

In the region of the return transport route, a device 18 is provided for ejecting load carriers 2′ that are not completely emptied and/or are soiled. While the soiled load carriers are sent to a service station (not shown in detail), the load carriers that are not completely emptied are sent to a lost-and-found station. Since the load carriers are linked to the personal identifier of the person they belong to, the person can then be paged specifically and asked to go to the lost-and-found station.

With reference to FIG. 2, the luggage drop-off region 1 is described in more detail below using the example of the drop-off station 1a. Thus, the drop-off station 1a has a first identification device 10 for detecting a personal identifier (in particular, biometric features) of the person, which is preferably designed as a camera. The personal identifier of the person is linked to the load carrier 2 provided at the drop-off station 1a by means of a data processing device 11, in which an identifier attached to the load carrier is read out with a reading device (not shown in detail) and linked to the personal identifier of the person. The identifier on the load carrier can be formed, for example, by an RFID, a QR code, or a similar marking.

As soon as the person's personal identifier is detected, a cover 12 opens, releasing the load carrier for loading. In the illustrated embodiment, the load carrier is box-shaped and open at the top. The person can then stow his/her luggage in the load carrier, wherein visual and/or acoustic instructions can be given to the person via a first information device 13, which in particular comprises a monitor and a loudspeaker. In particular, in this way it can be pointed out that a specified maximum load limit is not to be exceeded. For this purpose, the load carrier can have a corresponding marking. However, it is also conceivable that the load carrier 2 may be laden in such a way that the luggage 14 does not protrude beyond the dimensions of the load carrier 2.

A first monitoring device 15, which is formed by a camera, for example, detects the loading state of the load carrier 2, and, in the event of an undesirable loading state, a corresponding indication is given via the first information device 13. Since in the example shown the luggage 14 protrudes beyond the dimensions of the load carrier 2, the person could be asked to place the luggage correctly or to request a second load carrier. There is also the option to request help from an employee if a person is having trouble complying.

If the luggage is properly stowed in the load carrier 2, the luggage drop-off process can be completed in automated fashion by an inspection, in particular after a specified time, showing that there is no longer a person at the drop-off station 1a, so that an automated transporting away of the load carrier 2 can be initiated. However, it could also be provided that the person close the load carrier with a cover or a lid, wherein any such cover of the load carrier could also be lifted off and put in place in automated fashion. Alternatively, the closing could be completed by pressing a button or in a similar manner. If the person leaves the pick-up station without confirmation, he or she may be prompted to make a confirmation via the first information device 13. Should the person nevertheless leave, which could possibly be prevented by a blockable exit, an automatic transporting away can be initiated after a specified time has elapsed.

For the transporting away, the cover 12 first closes and/or a gate 17 opens to allow the load carrier 2 to be transported away. The transport of the load carrier 2 takes place via the transport system 8 and/or a provision system 16 connected to the transport system 8, wherein the first monitoring device 15 is coupled to the provision system 16 and/or the transport system 8 in such a way that the transporting away of the load carrier 2 from the drop-off station 1a is blocked (gate 17 remains closed) if an undesirable loading state of the load carrier 2 is detected. The load carrier 2 laden with luggage is then supplied to the luggage inspection station 3, while the person goes to the person inspection station 4.

The drop-off station 1a is assigned a buffer region 19 for returned, empty load carriers 2, wherein, in the drop-off station 1c, the next empty load carrier is provided via the transport system 8 or the provision system 16.

In the following, the luggage pick-up region 6 is explained in more detail using the example of the removal station 6a, with reference to FIG. 3.

The removal station 6a can fundamentally be constructed similarly or identically to the drop-off station 1a. Thus, the removal station 6a has a second identification device 20 for detecting the personal identifier of the person standing in front of the removal station, wherein the second identification unit 20 is linked to a second provision system 21 in order to transfer the load carrier 2 linked to the personal identifier of the person to this removal station 6a. For this purpose, the luggage pick-up region 6 has at least one buffer 22 for a plurality of load carriers 2 laden with luggage, wherein a plurality of the removal stations, e.g., the removal stations 6a, 6b, and 6c, are assigned to the buffer 22. The second provision system 21 is designed to transfer the load carriers 2 laden with luggage from the buffer 22 to one of the removal stations 6a, 6b, 6c, wherein the buffer 22—regardless of the order in which the load carriers 2 were introduced into the buffer 22—is capable of transferring the load carriers 2 to each of the associated pick-up stations in any order. The person who wants to pick up their luggage can therefore go to any removal station 6a, 6b, 6c that is currently free and is identified there by the second identification device 20, so that the load carrier 2 linked to his personal identifier is transferred from the buffer 22 to this removal station.

As soon as the associated load carrier 2 is provided in the removal station, a cover 23 opens, making the load carrier 2 accessible for unloading. Information can be provided to the person via an input and/or output unit 24. A second monitoring device 25, which is formed for example by a camera, detects the loading state of the load carrier 2. Via the input and/or output unit 24, the person can be made aware in particular that there are still pieces of luggage/objects in the load carrier 2. After complete removal, for example the passenger can be wished a good flight, and/or the departure gate can be displayed.

In an advantageous embodiment, a sensor unit is provided at the existing removal stations, which unit is formed for example by the second identification unit 20, which is designed to determine the presence of a person located in front of the removal station, and which is linked to the second monitoring unit 25 and the second provision system 21 in such a way that the emptying process is completed by removing the emptied load carrier 2 if the sensor unit does not detect a person in front of the removal station 6a and the load carrier 2 is empty. In this way, the removal station can be made available to the next person as quickly as possible.

Once the removal process is completed, the cover 23 closes and/or a gate 26 opens to allow the load carrier 2 to be transported away. The transport of the load carrier 2 takes place via the second provision system 21 and/or the transport system 8, wherein the second monitoring device 25 is coupled to the second provision system 21 and/or the transport system 8 in such a way that the removal of the load carrier 2 from the removal station 1a is blocked (gate 26 remains closed) if there is still an object in the load carrier 2. If the load carrier 2 is empty, the return transport to luggage drop-off region 1 is initiated. The next removal process can then be initiated by the detection, by the second identification device 20, of the next person standing in front of the removal station.

According to a preferred embodiment of the invention, the second monitoring device 25 in the removal stations 6a, 6b, 6c can also be able to detect soiling of the load carrier 2—for example, due to a leaked liquid. Soiled load carriers could then be ejected at the device 18 (FIG. 1). Ejection could also occur in the case of a load carrier that is not, or not completely, emptied, if the 10 person is supposed to leave the removal station 6a, 6b, 6c before the emptying is complete.

1. Security inspection system, comprising
a luggage drop-off region (1) having one or more drop-off stations (1a, 1b, 1c) for dropping off luggage belonging to a person into at least one load carrier (2),
a luggage inspection station (3) for imaging inspection of the luggage,
a luggage pick-up region (6) having one or more removal stations (6a, 6b, 6c),
a transport system (8) for transporting the load carriers (2) laden with luggage from the luggage drop-off region (1) via the luggage inspection station (3) to the luggage pick-up region (6) and for returning empty load carriers (2) to the luggage drop-off region (1),
characterized in that at least one first monitoring device (15) is provided in each of the provided drop-off stations (1a, 1b, 1c) for detecting the loading state of the load carriers (2), and/or at least one second monitoring device (25) is provided in each of the provided removal stations (6a, 6b, 6c) for detecting the loading state of the load carrier (2).

2. Security inspection system according to claim 1, characterized in that the first monitoring device (15) in the drop-off stations (1a, 1b, 1c) is designed to detect compliance with a specified degree of loading of the load carrier (2).

3. Security system according to claim 1, characterized in that the first and/or second monitoring device (15, 25) has at least one detector device and/or at least one camera.

4. Security inspection system according to claim 1, characterized in that the first and/or second monitoring device (15, 25) comprises an information device (13) and/or an input and/or output unit (24) which is designed to visually and/or acoustically reproduce an indication in the event of an undesirable loading state of the load carrier (2) in the drop-off station (1a, 1b, 1c) and/or in the event of a load carrier (2) in the removal station (6a, 6b, 6c) that is not completely emptied.

5. Security inspection system according to claim 1, characterized in that the first monitoring device (15) is coupled to the transport system (8) and/or a provision system (16) and is designed to block the removal of a load carrier (2) during the dropping off of the luggage and/or in the event of an undesirable loading state of the load carrier (2).

6. Security inspection system according to claim 1, characterized in that the load carriers (2) are box-like and are formed having at least one opening.

7. Security inspection system according to claim 1, characterized in that at each drop-off station (1a, 1b, 1c) a first identification device (10) is provided for detecting a personal identifier of the person, which interacts with a data processing device (11) for linking the personal identifier of the person with the load carrier (2) in which the person's luggage is located.

8. Security inspection system according to claim 1, characterized in that the luggage pick-up region (6) has at least one buffer (22) for a plurality of load carriers (2) laden with luggage, wherein each buffer (22) is assigned a plurality of the removal stations (6a, 6b, 6c), and provides a provision system (21) for transferring a load carrier (2) laden with luggage from the buffer (22) to one of the removal stations (6a, 6b, 6c).

9. Security inspection system according to claim 8, characterized in that each removal station (6a, 6b, 6c) is equipped with a second identification unit (20) for detecting the personal identifier of the person standing in front of the removal station (6a, 6b, 6c), wherein the second identification unit (20) is linked to the provision system (21) in order to transfer the load carrier (2) linked to the personal identifier of the person to this removal station (6a, 6b, 6c).

10. Security inspection system according to claim 1, characterized in that the transport system (8) is designed to eject load carriers (2) that are not completely emptied and/or are soiled.

11. Security inspection system according to claim 1, characterized in that input and/or output units (24) are provided at the provided removal stations (6a, 6b, 6c), which units are designed to provide information to the person and/or to confirm the emptying process of the load carrier (2) by the person.

12. Security inspection system according to claim 1, characterized in that a sensor unit is provided at the provided removal stations (6a, 6b, 6c), which unit is designed to determine the presence of a person located in front of the removal station (6a, 6b, 6c), and which is linked to the second monitoring unit (25) and to the provision system (21) in such a way that the emptying process is completed by transporting away the emptied load carrier (2) if the sensor unit does not detect a person in front of the removal station (6a, 6b, 6c) and the load carrier is empty.

13. Security inspection system according to claim 1, characterized in that the luggage drop-off region (1) or each drop-off station (1a, 1b, 1c) provides a blockable exit for persons, wherein the exit can be blocked upon detection of an undesirable loading state.

14. Security inspection method, characterized in that a security inspection system according to claim 1 is used, wherein
a person in a luggage drop-off region (1) with one or more drop-off stations (1a, 1b, 1c) drops off his or her luggage in at least one load carrier (2) provided at a drop-off station (1a, 1b, 1c),
the luggage is subjected to an imaging examination at a luggage inspection station (3),
the person picks up his or her luggage in a luggage pick-up region (6) having one or more removal stations (6a, 6b, 6c), and
the load carriers (2) laden with luggage are transported from the luggage drop-off region (1) via the luggage inspection station (3) to the luggage pick-up region (6), and the empty load carriers (2) are transported back to the luggage drop-off region (1),
characterized in that, in each of the provided drop-off stations (1a, 1b, 1c), the loading state of the load carriers (2) is monitored by means of at least one first monitoring device (15), and/or, in each of the provided removal stations (6a, 6b, 6c), the loading state of the load carriers (2) is monitored by means of at least one second monitoring device (25).

15. Security inspection method according to claim 14, characterized in that at each drop-off station (1a, 1b, 1c) a personal identifier of the person is detected by means of a first identification device (10), and the personal identifier of the person is linked by means of a data processing device (11) to the load carrier (2) in which the person's luggage is located.

16. Security inspection method according to claim 14, characterized in that
the person confirms via an input unit the completion of the loading of the luggage into the load carrier (2), and the load carrier (2) is then transported away, or
the person signals the completion of the loading of the luggage by closing a cover of the load carrier (2), whereupon the load carrier (2) is transported away, or
the first monitoring device (15) detects luggage in the load carrier (2), and a sensor unit (15) determines that there is no person at the drop-off station (1a, 1b, 1c), whereupon the load carrier (2) is transported away.

17. Security inspection method according to claim 14, characterized in that
after emptying the load carrier (2) at the removal station (6a, 6b, 6c), the person completes the emptying process by making an input at an input unit (24), and the load carrier (2) is thereupon transported away, and/or
the emptying process of the load carrier (2) in a removal station (6a, 6b, 6c) is ended in automated fashion and the load carrier (2) is transported away, by the second monitoring unit (25) detecting an empty load carrier (2) and a sensor unit determining that there is no person at the removal station (6a, 6b, 6c).
